(19) United States
(12) Patent Application Publication
(10) Pub. No.: US 2007/0244829 A1
(43) Pub. Date: Oct. 18, 2007

(54) Method and apparatus for delivery of objects

(76) Inventors: Thomas W. Boswell, Eustis, FL (US); Michael D. Lamb, Desoto, MO (US); Benny Franklin Jones, Dittmer, MO (US)

Correspondence Address: MCANDREWS HELD & MALLOY, LTD, 500 WEST MADISON STREET, SUITE 3400, CHICAGO, IL, 60661, US

(21) Appl. No.: 11/406,098

(22) Filed: Apr. 18, 2006

(51) Int. Cl. H04L 9/00

(52) U.S. Cl. 705/65

(57) ABSTRACT

A system and method for delivering an object to a user is disclosed. The method may include storing authentication information for a user. The method may also include receiving a first user input and comparing the stored authentication information with the first user input. The first user input may include data stored on an electromagnetic card. The method may also include receiving a second user input and comparing the stored authentication information with the second user input. The second user input may include a personal identification number. If the user has been authenticated, the method may include communicating an electronic command for unsecuring at least one object. The electronic command may be communicated to a housing unit having compartments for housing objects. The location of the object may be communicated to the user and the user may pick up the object from the unsecured compartment.

### BACKGROUND OF THE INVENTION

The present invention generally relates to a system and method for improved delivery of objects. Particularly, the present invention relates to an improved system and method for delivering objects to a particular user through the use of a secure housing unit.

Various industries distribute secure objects to users or customers. In general, the secure objects may be secured and distributed by representatives of the business. For example, a customer that has previously made a reservation for a hotel room often checks-in to the hotel by typically meeting with a human employee representing the hotel upon arrival at the hotel. The human employee typically searches for the customer's reservation in a computer database. The human employee then typically secures payment from the customer. The human employee also gives the customer her key to her room and communicates to the customer the location of the room.

In another example, a customer that has previously made a reservation to pick-up a rental car often meets with a human employee representing the rental car company upon arriving at the rental car location. The human employee typically searches for the customer's reservation in a computer database. The human employee then typically secures payment from the customer. The human employee also gives the customer his key to his car and communicates to the customer the location of the vehicle.

In another example, a customer wishing to shop for an automobile for purchase typically goes to an automobile sales lot and meets with a salesperson. The customer typically discusses information about automobiles. If the customer is interested in an automobile, the salesperson may offer the customer a “test drive.” The salesperson may give the customer the keys to the automobile and let the person take the car for a “test drive.”

In the above examples, as is typical, the secure objects are generally secured and distributed by representatives of the business. Such systems and methods are time consuming and inefficient for a customer. The efficiency of obtaining an object generally relies on human intervention. Depending on the demand placed on the human and the efficiency of the human in performing the distribution tasks, a customer may wait an inefficient amount of time to receive an object.

Accordingly, a need exists for a system and method that is more efficient in the distribution of secure objects. Such a system and method may allow users to complete a transaction in a minimal amount of time and simplify the distribution of objects for a distributor.

### SUMMARY OF THE INVENTION

Certain embodiments of the present invention include a method of delivering an object to a user. The method includes storing authentication information. In an embodiment, reservation information is also stored. The method also includes receiving a first user input. In an embodiment, the first user input includes data stored on an electromagnetic card, including the name of the user. The method also includes the step of comparing the authentication information with the first user input. The method includes receiving a second user input. In an embodiment, the second user input includes a personal identification number. The method also includes communicating an electronic command to unsecure the object and communicating the location of the object to the user. In an embodiment, the location of the object is communicated to the user visually. The method may also include detecting the absence of the object and communicating an electronic signal to identify the absence of the object.

Certain embodiments of the present invention include a system for delivering an object to a user. In an embodiment, the object may be a key. The system includes an input unit for receiving input from a user. In an embodiment, the input unit may include a touch screen display. The input unit may also include an electromagnetic card reader or a contact-less card reader. The system may also include a housing unit for housing the object. The housing unit may have an access mechanism for controlling access to the object. In an embodiment, the housing unit may have a plurality of compartments. In an embodiment, the system may include a display unit for displaying information for loading the plurality of compartments of the housing unit. The system also includes a computer unit for manipulating and storing data. The computer unit executes computer software for communicating an electronic command to the housing unit. The electronic command may be a command to unlock the access mechanism of the housing unit. In an embodiment, the data stored on the computer unit includes reservation and authentication data. In an embodiment, the system may include a second input unit.

Certain embodiments of the present invention also include a computer-readable storage medium including a set of instructions for a computer. The set of instructions include a storing routine for storing authentication information. The set of instructions also include a first receiving routine for receiving a first user input and a first comparing routine for comparing the authentication information with the first user input. The set of instructions also include a second receiving routine for receiving a second user input. The set of instructions also include a second comparing routine for comparing the authentication information with the second user input. The set of instructions also include a first communicating routine for communicating an electronic command to unsecure the object and a second communication routine for communicating the location of the object to the user.

### BRIEF DESCRIPTION OF THE DRAWINGS

FIG. 1 illustrates an example of a system that may be used in accordance with an embodiment of the present invention.

FIG. 2 illustrates an input console that may be used in accordance with an embodiment of the present invention.

FIG. 3 illustrates an example of the output of the computer unit output for a loading session in a hotel context.

FIG. 4 illustrates an input console that may be used in accordance with an embodiment of the present invention.

FIG. 5 illustrates an input console that may be used in accordance with an embodiment of the present invention in the hotel context.

FIG. 6 illustrates an example of the output of the computer unit output for a loading session in a rental car context.

FIG. 7 illustrates an input console that may be used in accordance with an embodiment of the present invention in the rental car context.

FIG. 8 illustrates an example of the output of the computer unit output for a loading session in an automobile dealership context.

FIG. 9 illustrates an input console that may be used in accordance with an embodiment of the present invention in the automobile dealership context.

FIG. 10 illustrates a state diagram that illustrates an example of a main program state progression that may be used in accordance with an embodiment of the present invention.

FIG. 11 illustrates a state diagram that illustrates an example of an input/service routine that may be used with the main program in accordance with an embodiment of the present invention.

FIG. 12 illustrates a state diagram that illustrates an example of a file compare routine that may be used with the main program in accordance with an embodiment of the present invention.

FIG. 13 illustrates a method for delivering one or more objects to a user that may be used in accordance with an embodiment of the present invention.

### DETAILED DESCRIPTION OF THE INVENTION

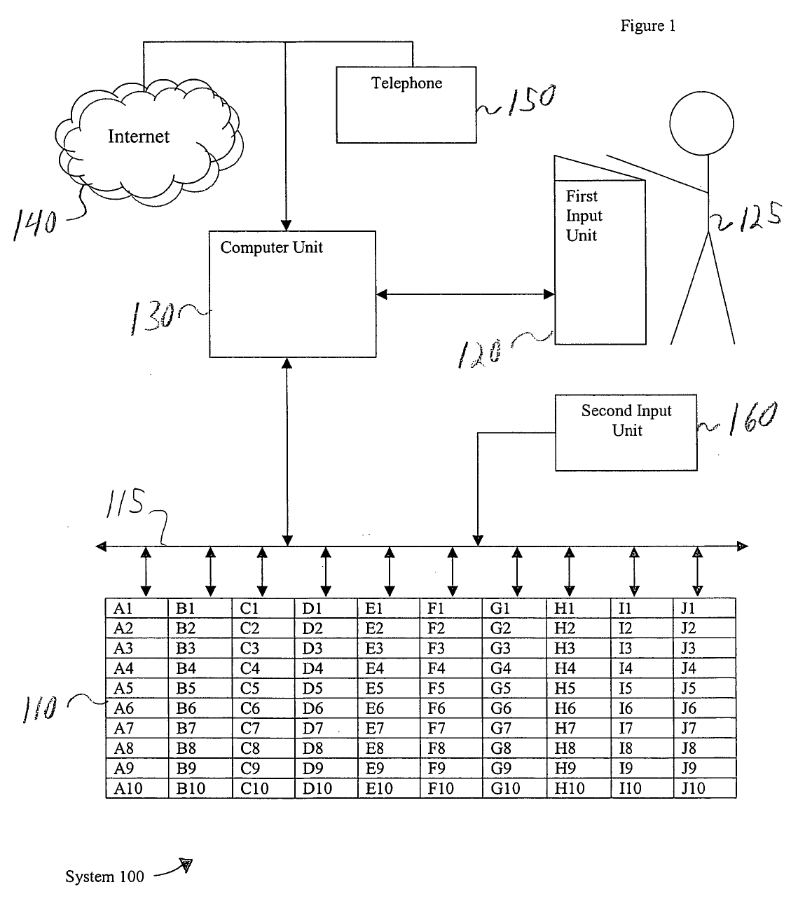

FIG. 1 illustrates a system 100 for delivering an object to a user. The system 100 illustrates, as an example, a housing unit 110, a first input unit 120, a user 125, and a computer unit 130. The system 100 also illustrates an Internet input 140, a telephone input 150, and a second input unit 160. Also shown is a representation of a network 115. Generally, the components of the system 100 may be single units, separate units, may be integrated in various forms, and may be implemented in hardware and/or in software.

The computer unit 130 represents, in general, hardware equipment and computer software. The hardware equipment may be a single unit, or may be composed of a plurality of devices. The hardware equipment may be distributed or centralized. For example, the computer unit 130 may include such computer hardware as one or more server devices performing similar or various functions, one or more database devices, one or more processors, one or more network connections, and various inputs and output ports. The actual physical computer units may be separate units, part of a single unit, a computer system, or part of a computer system. The computer software may execute on the computer unit 130, or may execute as part of other devices, such devices comprise the first input device 120 and second input device 160. The use of various hardware and software combinations, implementations, and architectures are contemplated and within the scope of the present invention.

The computer unit 130 is electrically connected to the various components of the system 100. For example, the computer unit 130 is electrically connected to the first input unit 120 and, through the network 115, the housing unit 110. The computer unit 130 is also electrically connected to the second input unit 160 through network 115. The computer unit 130 is also electrically connected to the public telephone network 150 and the Internet 140. In the embodiment shown, the computer unit 130 is electrically connected to the components of the system 100 by a wire. Alternatively, the computer unit 130 may be wirelessly connected, through electronic transmission, to any of the components of the system 100. Additionally, any of the system 100 components may be wirelessly connected to each other.

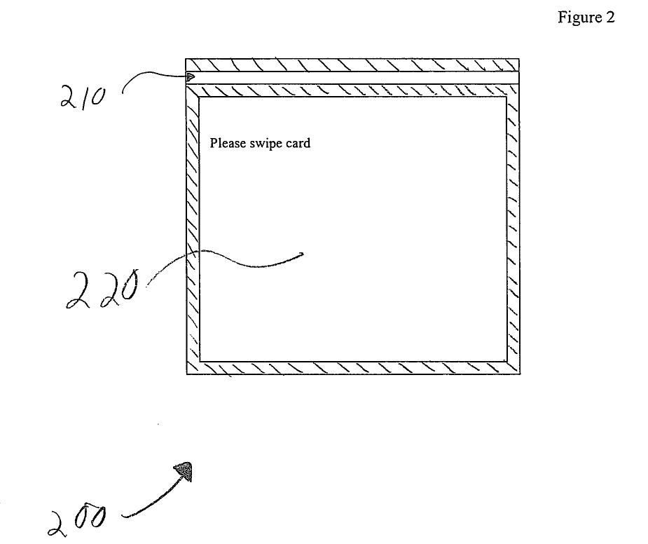

The first input unit 120 may accept communication from a user 125 as input. Such communication may be in the form of electronic input. Such electronic input may be input on an input console. FIG. 2 illustrates an input console 200 that may be used as part of the first input unit 120 in accordance with an embodiment of the present invention. FIG. 2 illustrates the face of the input console 200. The face of the input console 200 is the portion of the input console 200 that the user may interact with. As shown in FIG. 2, the input console 200 may have an electromagnetic card reader 210. The electromagnetic card reader 210 may read information available on electromagnetic cards, such as information available on a credit card. A user 125 may swipe an electromagnetic card through the card reader 210 as input to the first input unit 120. The first input unit 120 may also have a display screen 220. The display screen 220 may display information to a user. In an embodiment, the display screen may be a touch screen to display information to and receive input from a user 125. Other forms of input are contemplated for the input console 200. For example, the input console 200 may utilize a keyboard and/or computer mouse as input devices. Moreover, the card reader 210 is not limited to a particular type of card reader. For example, the card reader 210 may be an insertion card reader rather than a swipe card reader. The first input unit 120 may be a single unit or may be composed of a plurality of devices.

The input console 200 may also utilize a facial recognition scanner or finger print scanner as input devices, for example. In addition, the input console 200 may also utilize a reader of contact-less smart cards, such as cards having a “pass and go” technology. Such smart cards or objects may be read by the input console when the smart card is within a particular proximity to the reader. Such smart cards may also encompass smart chips, and the input console 200 may read the smart chips. The input console 200 may read any object or form sufficient to identify a user.

In an embodiment, the computer unit 130 may have a plurality of potential input sources. For example, the input sources may include input from users of the Internet 140, users of a telephone 150, or users of a second input unit 160. The second input unit 160 may be a computer not communicating with the computer unit 130 over the Internet. For example, the second input unit 160 may be a computer operating on the same local area network as the computer unit 130. A user communicating with the computer unit 130 at least partially through the Internet, may transact with the computer unit 130 and store information on the computer unit 130. A user may transact with the computer unit 130 over the Internet utilizing a standard personal computer, personal digital assistant, or Internet capable mobile phone, for example. The user input may be a reservation, such as a hotel reservation, for example. The reservation may be stored at the computer unit 130.

A user communicating with the computer unit 130 through the telephone may transact with the computer unit 130, at least partially through the public telephone network. A user may transact with the computer unit 130 over the public telephone network by using voice commands, understandable by the computer unit 130. Additionally, a user may transact with the computer unit 130 over the public telephone network by using touch-tone commands that are typed into the user's telephone keypad. The user may communicate with the computer unit 130 and store information on the computer unit 130. Such information may be a reservation, such as a hotel reservation, for example. The reservation may be stored at the computer unit 130.

A user communicating with the computer unit 130 using the second input unit 160 may transact with the computer unit 130, at least partially through a local area network. The local area network may be represented by network 115 in FIG. 1. The second input unit 160 may be a standard personal/office computer having a mouse and keyboard, for example. The second input unit 160 may also be a personal digital assistant or mobile phone. In an embodiment, the second input unit 160 may be used when a user telephones a business to speak with a human in order to make a reservation. The human may use the second input unit 160 to communicate with the computer unit 130 and input and store information at computer unit 130.

In an embodiment, the first input unit 120 may be used to communicate with the computer unit 130 for administrative/service purposes. In such an embodiment, a user may enter a service code onto a touch screen display 220 or swipe a service card in the electromagnetic card reader 210. The first input unit 120 and/or the computer unit 130 identifies the input as a service request and opens an administrative menu on the display 220.

The housing unit 110 may be one or more units composed of a plurality of securable compartments. The securable compartments may be designed to secure an object. In an embodiment, the object may be secured by controlling access to the object from the general public. The securable compartments may be various shapes and sizes depending on the size and shape of the objects. For example, the securable compartments may include bins, drawers, or rooms. The separate compartments as shown in the housing unit 110 are labeled A1-A10 and A1-J1, respectively. Accordingly, the housing unit 110 illustrates 100 separate secure compartments. The number of secure compartments is not limited to 100. More or less secure compartments may be used and any number of housing units 110 may be used in accordance with an embodiment of the present invention.

In one embodiment of the system 100, the separate secure compartments of the housing unit 110 may be loaded with the object. In an embodiment, a human physically loads the objects into the appropriate compartments of the housing unit 110. In an embodiment, the secure compartments of the housing unit 110 may be front loaded. In another embodiment the secure compartments of the housing unit 110 may be rear loaded.

If the secure compartment is front loaded, the object may be placed into the compartment in a similar manner as the object is removed from the secure compartment. For example, a front loaded secure compartment may be the shape of a cube. Five of the six sides may be the walls of the cube and the sixth side may be a door. The door may be used to load the object into the secure compartment. For example a human physically places the object into the secure compartment using the door. A user, at the time of pick up, may remove the object from the secure compartment through the door. The doors of the secure compartments may have a locking mechanism that is electronically controlled by the computer unit 130.

If the secure compartment is rear loaded, the object may be placed into the compartment in a different manner than is used to remove the object. For example, a rear loaded secure compartment may be in the shape of a cube. A rear loaded secure compartment may have four wall sides, one side having a door, and one side that is open. The open side of the secure compartment may not be accessible to the public. The open side may be used for loading the object into the compartment. An example of the use of the rear loaded embodiment is when the housing unit 110 is built into a wall. Various users have access to the side of the housing unit having secure doors. As the secure doors are generally locked, unauthorized individuals do not have access to the objects in the housing unit. The various users generally do not have access to the non-public area of the vender. The non-public area may have the “open,” rear side, of the securable compartments. Individuals authorized to load the secure compartments may have access to the rear side of the housing unit 110. The authorized individuals may place the objects into the compartments through the open side of the compartments. Front and rear loading is applicable to the securable compartments regardless of type, including bins, drawers, and/or rooms. Other techniques of loading the secure compartments are contemplated and within the scope of the present invention.

In operation, the system 100 may be used to deliver one or more objects to a user. The object(s) may be any number of items, depending on the context of the system 100. For example, in the context of hotel, the objects may include keys to the user's room, a fax the user has received at the hotel, tickets to a show the user has requested from the concierge, a guide to local attractions, or other objects a user may generally obtain from the service counter of a hotel. In the context of a rental car business, the object(s) may include the key to the rental car, a map of the local area, and a receipt for the transaction. In the context of an automobile dealership, the objects may include the key to an automobile, a sales brochure about the automobile, and financing information the user may desire to purchase the automobile. Each of these embodiments is discussed below.

In the context of utilizing the system 100 in a hotel environment, a user may make a reservation to stay at the hotel for a particular length of time. The user may make the reservation in a number of ways, including communicating with the computer unit 130 through the Internet 140, over the telephone 150, through the second input unit 160, or through another technique. While making the reservation, the user provides various information to the computer unit 130, including the user's name, credit card number and billing information, and other applicable information. The information provided at the time of the reservation is saved at the computer unit 130. Prior to ending the transaction, the computer unit 130 generates and communicates to the user a confirmation number, i.e. personal identification number (PIN) that the computer unit 130 stores as part of the user's reservation.

Prior to the scheduled reservation date, the computer unit 130 may send a reminder to employees of the hotel that a reservation for a particular user is approaching. For example, the computer unit 130 may send an email to hotel employees detailing the various check-in reservations for a particular day. Alternatively, the computer unit 130 may generate a print out detailing the various check-in reservations for a particular day. Alternatively, the computer unit 130 may display on a display screen details of the various check-in reservations for a particular day. The display screen may or may not be part of an employee's computer. In an embodiment, the display screen is located in a non-public area for employees of the hotel to review, particularly near the rear of a housing unit 110 in a rear loaded unit. Other forms of computer unit 130 output for reservation reminders are contemplated and within the scope of the present invention.

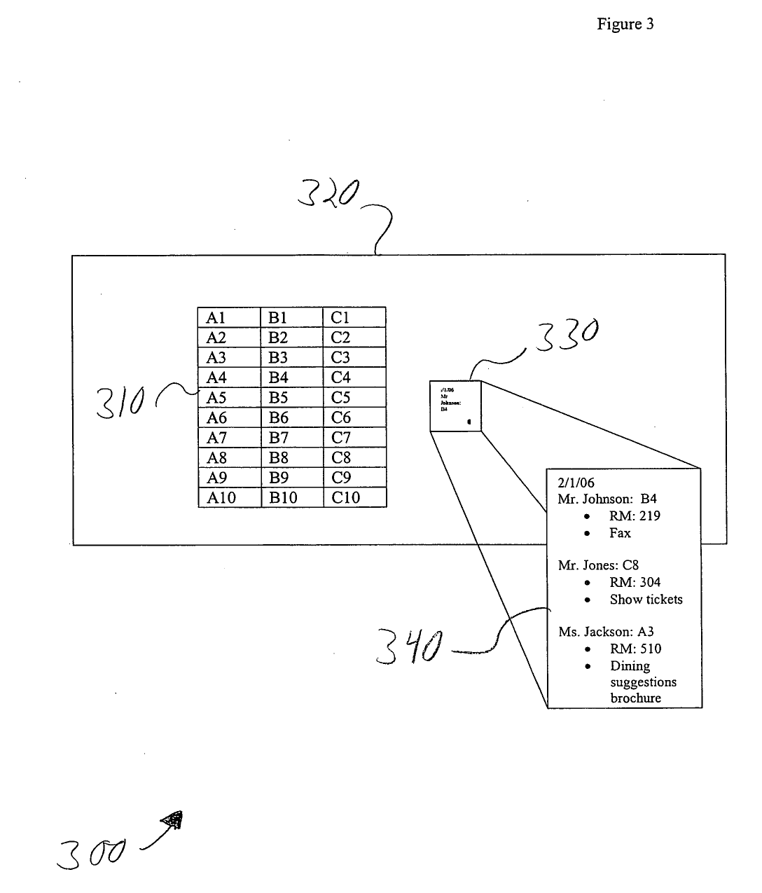

With each check-in reservation in the hotel context, the computer unit 130 also outputs an assignment of a securable compartment and a listing of the objects to be loaded into the securable compartment. FIG. 3 illustrates an example of the computer unit 130's output for a loading session in the hotel context 300.

FIG. 3 illustrates a subset 310 of the housing unit 110 built into wall 320 of a hotel. The rear, non-public side of the housing unit 310 is depicted. In an embodiment, the compartments of the housing unit 310 are rear loaded. FIG. 3 also illustrates a display screen 330. The display screen 330 is built into the wall near the housing unit 310. A larger blow-up of the contents displayed on the display screen are shown in blow-up 340 as an example.

In an embodiment, the display screen 330 may display the check-in reservations for a particular day, as represented by the “2/1/06” shown on the blow-up 340. The information on the blow-up 340 indicates the user that the reservation is for, the compartment to load the user's contents into, and the objects to load into the assigned compartment. For example, for “Mr. Johnson” on the blow-up 340, the assigned compartment is B4. The assigned room is “RM 219” and a fax is waiting for Mr. Johnson. A hotel employee may review the display unit 330 and understand to load a key for room 219 into compartment B4 and also load a fax for Mr. Johnson into compartment B4. In an embodiment, the display unit 330 may be in communication with one or more display unit input devices, such as a computer keyboard or computer mouse. The display unit input devices may allow the employee who performs the loading of the objects to indicate to the computer unit 130 that the loading is complete. Alternatively, the compartments in which the objects are loaded may have sensors that can sense whether an object is in the compartment. The compartment sensors may be in communication with the computer unit 130 to indicate that the compartment is occupied.

In such a manner, an employee may load keys to some, or all of a hotel's rooms into a housing unit 110. The number of keys to be loaded may depend on the number of reservations for the day. In another embodiment, a hotel may have multiple check in times, and thus may have multiple loading sessions for the housing unit 110. For example, a hotel may have an early check-in time and a late check-in time. Customers may select which check-in time they prefer as part of making their reservation. The computer unit 130 may then display an early loading session and a late loading session for an employee to follow. An employee may load the housing unit with the keys for that particular check-in time. By using multiple check-in times, the system 100 may operate with a smaller number of compartments.

Once the housing unit 110 is loaded by the employees, the objects are ready to be distributed to users 125. Upon arriving at the location of the hotel, the user 125 may approach the first input unit 120. The user may review the input console 200 of the first input unit 120 for instructions to initiate the transaction.

The display unit 220 may instruct the user 125 to begin the transaction. For example, the display unit 220 may instruct the user to swipe their credit card in the card reader 210. The information on the credit card is read by the card reader 210 and communicated to the computer unit 130. The computer unit 130 compares at least some of the information on the credit card with the information stored in the computer unit 130 database. For example, the computer unit 130 may compare the name on the credit card with the name's of individuals in the computer unit 130 database. The computer unit 130 may also compare the credit card number on the credit card with credit card numbers in the computer unit 130 data base. In an embodiment, in order to maximize search efficiency, the computer unit 130 may first search files with expected check-in dates equal to the date the card was swiped. For example, the computer unit 130 may receive the first user input and compare the first user input with the stored information in files having an expected check-in date of the date the card was swiped. Alternatively, the computer unit 130 searches files in the order the files are stored. Any technique to compare information may be used.

If the credit card that is swiped through the card reader 210 is the same credit card as that which the user provided at the time of booking the reservation, that credit card is charged. If the credit card that is swiped through the card reader 210 is different than the credit card that was provided at the time of booking the reservation, the computer unit asks the user if the user wishes to charge the credit card on file or charge the new credit card. The computer unit has the ability to communicate with credit card companies to verify and charge a credit card.

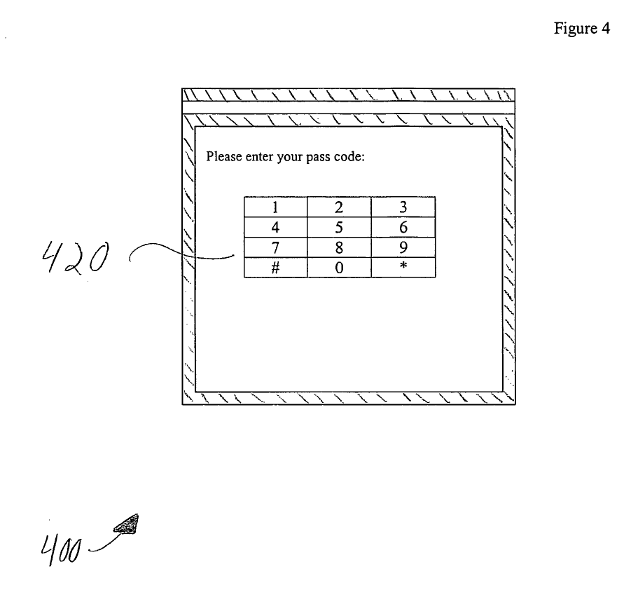

If the computer unit 130 finds a match of the first user input with previously stored information, the computer unit 130 returns a message of success and displays a request for additional verification from the user 125. In an embodiment, the computer unit 130 displays a numerical key pad on the touch screen 220 as illustrated in FIG. 4. The input console 400 displays a numerical keypad on touch screen 420. The user is requested to enter the PIN number that was issued to them at the time of making the reservation. The user then enters the PIN. In an embodiment, the PIN number is compared with the PIN number stored in the file found to match the first user input data. A match of both the first user input and the second user input is generally used to verify the identity of the user.

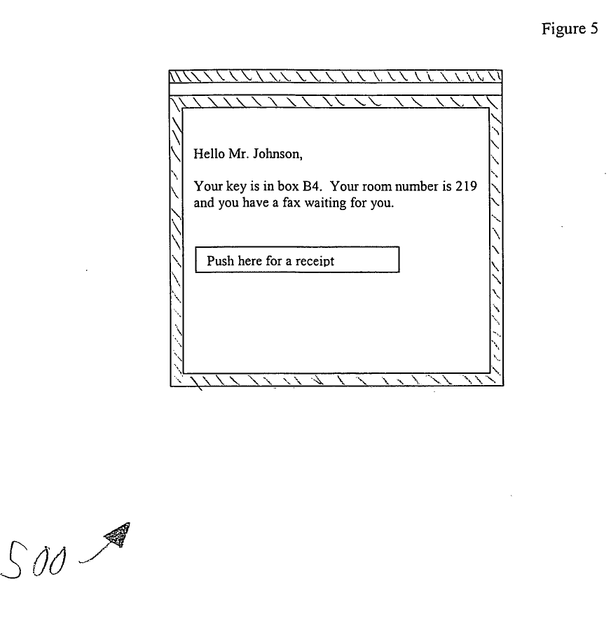

If the PIN number of the second user input matches the stored PIN number, a return message is sent to the first input unit 120. The return message includes the location, in the housing unit 110, of the key for the user's reservation and any additional objects in the compartment. For example, in FIG. 5, input console 500 illustrates screen 520 displaying a welcome message for Mr. Johnson. Mr. Johnson is an authenticated user and the location of his key and other appropriate objects are displayed. Additionally, the user may communicate to the input console 520 that the user would like a printed receipt for the transaction.

Upon verification of the individual through information on the individual's credit card and a PIN, the transaction at the first input unit 120 is complete. The computer unit 130 sends an electronic signal to the housing unit 130 to unlock the compartment assigned to the individual. In the example above, the computer unit 130 will unlock compartment B4 for a certain period of time. The compartment may stay unlocked for a period of time determined to be sufficient for a user to find the appropriate compartment. If the individual does not retrieve the object in the given period of time, the compartment relocks. For example, if the individual's key is in compartment B4, the computer unit 130 sends and electronic communication to the housing unit 110 to unlock compartment B4. The user was previously told that the key is in compartment B4 by the first input unit 120. The user may then remove the key from compartment B4. If the user does not remove the key from the compartment B4 in a designated period of time, the compartment B4 will relock. In an embodiment, upon removal of the object by the user, the housing unit 110 may send a message to the computer unit that the object has been removed from the compartment and the compartment is free for reassignment.

In the context of a rental car business, the object(s) may include the key to the rental car, a map of the local area, and a receipt for the transaction. A user may make a reservation for a rental car prior to picking up the rental car. A user may make a reservation to rent a car for a particular length of time. The user may make the reservation in a number of ways, including communicating with the computer unit 130 through the Internet 140, over the telephone 150, through the second input unit 160, or through another technique. While making the reservation, the user provides various information to the computer unit 130, including the user's name, credit card number and billing information, and other applicable information. The information provided at the time of the reservation is saved at the computer unit 130. Prior to ending the transaction, the computer unit 130 generates and communicates to the user a confirmation number, i.e. personal identification number (PIN) that the computer unit 130 stores as part of the user's reservation.

Prior to the scheduled reservation date, the computer unit 130 may send a reminder to employees of the rental car company that a reservation for a particular user is approaching. For example, the computer unit 130 may send an email to rental car company employees detailing the various car reservations for a particular day. Alternatively, the computer unit 130 may generate a print out detailing the various car reservations for a particular day. Alternatively, the computer unit 130 may display on a display screen details of the various car reservations for a particular day. The display screen may or may not be part of an employee's computer. In an embodiment, the display screen is located in a non-public area for employees of the rental company to review, particularly near the rear of a housing unit 110 in a rear loaded unit. Other forms of computer unit 130 output for reservation reminders are contemplated and within the scope of the present invention.

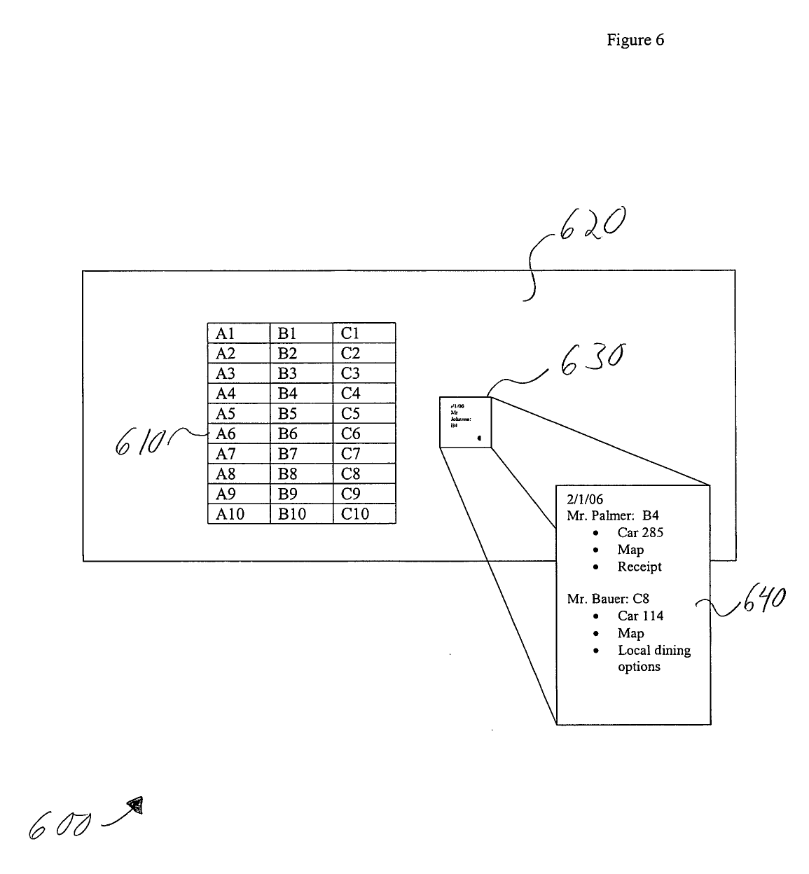

With each reservation in the rental car context, the computer unit 130 also outputs an assignment of a securable compartment and a listing of the objects to be loaded into the securable compartment. FIG. 6 illustrates an example of the computer unit 130's output for a loading session in the rental car context 600.

FIG. 6 illustrates a subset 610 of the housing unit 110 built into wall 620 of a rental car facility. The rear, non-public side of the housing unit 610 is depicted. In an embodiment, the compartments of the housing unit 610 are rear loaded. FIG. 6 also illustrates a display screen 630. The display screen 630 is built into the wall near the housing unit 610. A larger blow-up of the contents displayed on the display screen are shown in blow-up 640 as an example.

In an embodiment, the display screen 630 may display the car reservations for a particular day, as represented by the “2/1/06” shown on the blow-up 640. The information on the blow-up 640 indicates the user that the reservation is for, the compartment to load the user's contents into, and the objects to load into the assigned compartment. For example, for “Mr. Palmer” on the blow-up 640, the assigned compartment is B4. The assigned car is in space 285 and the car rental employee is told to include a receipt in the compartment. A rental car employee may review the display unit 630 and understand to load a key for car 285 into compartment B4 and also load a map and receipt for Mr. Palmer into compartment B4. In an embodiment, the display unit 630 may be in communication with one or more input devices so the employee who performs the loading of the objects can indicate to the computer unit 130 that the loading is complete.

In such a manner, an employee may load objects to some, or all of a car rental companies automobiles into a housing unit 110. The number of keys to be loaded may depend on the number of reservations for the day. Additionally, as users generally arrive at different times to pick up a rental car, the rental car company may have more frequent loading times. For example, the rental car company may load the keys on an hourly basis. Upon accepting the reservation, the rental car company may ask the user an expected time of arrival. The keys may be loaded based on the expected time of arrival. By using multiple loading sessions, the system 100 may operate with a smaller number of compartments.

Once the housing unit 110 is loaded by the employees, the objects are ready to be distributed to users 125. Upon arriving at the location of the car rental, the user 125 may approach the first input unit 120. The user may review the input console 200 of the first input unit 120 for instructions to initiate the transaction.

The display unit 220 may instruct the user 125 to begin the transaction. For example, the display unit 220 may instruct the user to swipe their credit card in the card reader 210. The information on the credit card is read by the card reader 210 and communicated to the computer unit 130. The computer unit 130 compares at least some of the information on the credit card with the information stored in the computer unit 130 database. For example, the computer unit 130 may compare the name on the credit card with the name's of individuals in the computer unit 130 database. The computer unit 130 may also compare the credit card number on the credit card with credit card numbers in the computer unit 130 data base. In an embodiment, in order to maximize search efficiency, the computer unit 130 may first search files with expected arrival dates and arrival times equal to the date and time the card was swiped. For example, the computer unit 130 may receive the first user input and compare the first user input with the stored information in files having an expected arrival data and time of the date and time the card was swiped. Alternatively, the computer unit 130 searches files in the order the files are stored. Any technique to compare information may be used.

If the credit card that is swiped through the card reader 210 is the same credit card as that which the user provided at the time of booking the reservation, that credit card is charged. If the credit card that is swiped through the card reader 210 is different than the credit card that was provided at the time of booking the reservation, the computer unit 130 asks the user if the user wishes to charge the credit card on file or charge the new credit card. The computer unit has the ability to communicate with credit card companies to verify and charge a credit card.

If the computer unit 130 finds a match of the first user input with previously stored information, the computer unit 130 returns a message of success and displays a request for additional verification from the user 125. In an embodiment, the computer unit 130 displays a numerical key pad on the touch screen 220 as illustrated in FIG. 4. The input console 400 displays a numerical keypad on touch screen 420. The user is requested to enter the PIN number that was issued to them at the time of making the reservation. The user then enters the PIN. In an embodiment, the PIN number is compared with the PIN number stored in the file found to match the first user input data. A match of both the first user input and the second user input is generally used to verify the identity of the user.

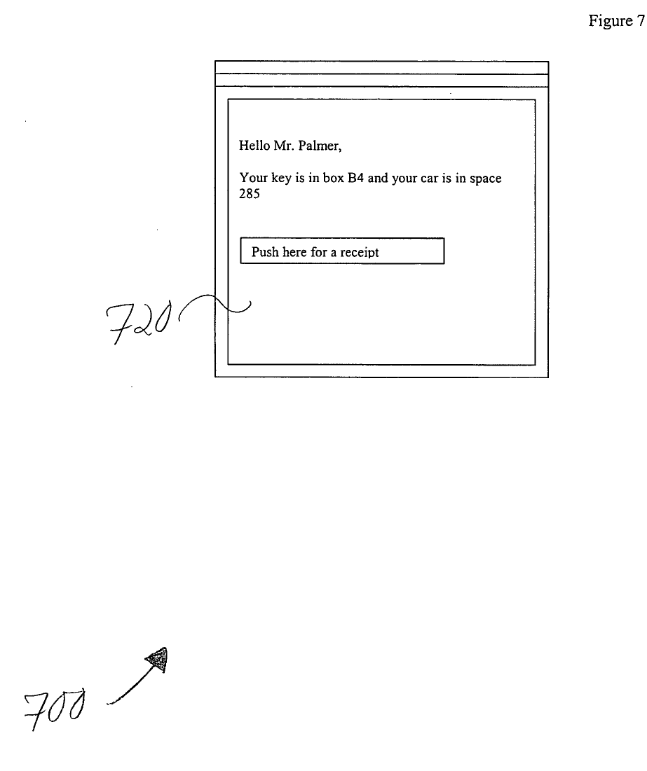

If the PIN number of the second user input matches the stored PIN number, a return message is sent to the first input unit 120. The return message includes the location, in the housing unit 110, of the key for the user's reservation and any additional objects in the compartment. For example, in FIG. 7, input console 700 illustrates screen 720 displaying a welcome message for Mr. Palmer. Mr. Palmer is an authenticated user and the location of his key and his car is displayed. Additionally, the user may communicate to the input console 720 that the user would like a printed receipt for the transaction.

Upon verification of the individual through information on the individual's credit card and a PIN, the transaction at the first input unit 120 is complete. The computer unit 130 sends an electronic signal to the housing unit 110 to unlock the compartment assigned to the individual. In the example above, the computer unit 130 will unlock compartment B4 for a certain period of time. The compartment may stay unlocked for a period of time determined to be sufficient for a user to find the appropriate compartment. If the individual does not retrieve the object in the given period of time, the compartment relocks. For example, if the individual's key is in compartment B4, the computer unit 130 sends and electronic communication to the housing unit 110 to unlock compartment B4. The user was previously told that the key is in compartment B4 by the first input unit 120. The user may then remove the key from compartment B4. If the user does not remove the key from the compartment B4 in a designated period of time, the compartment B4 will relock. In an embodiment, upon removal of the object by the user, the housing unit 110 may send a message to the computer unit that the object has been removed from the compartment and the compartment is free for reassignment.

In the context of an automobile dealership, the objects may include the key to an automobile, a sales brochure about the automobile, and financing information the user may desire to purchase or lease the automobile. A user may make a reservation to examine and test drive an automobile without being hassled by a salesman. The user may make a reservation to examine the car for a particular length of time. The user may make the reservation in a number of ways, including communicating with the computer unit 130 through the Internet 140, over the telephone 150, through the second input unit 160, or through another technique. While making the reservation, the user provides various information to the computer unit 130, including the user's name, credit card number and billing information, and other applicable information, such as driver's license number and insurance information. The information provided at the time of the reservation is saved at the computer unit 130. Prior to ending the transaction, the computer unit 130 generates and communicates to the user a confirmation number, i.e. personal identification number (PIN) that the computer unit 130 stores as part of the user's reservation.

Prior to the scheduled reservation date and time, the computer unit 130 may send a reminder to employees of the automobile dealership that a reservation for a particular user is approaching. For example, the computer unit 130 may send an email to automobile dealership employees detailing the various car reservations for a particular day. Alternatively, the computer unit 130 may generate a print out detailing the various car reservations for a particular day. Alternatively, the computer unit 130 may display on a display screen details of the various car reservations for a particular day. The display screen may or may not be part of an employee's computer. In an embodiment, the display screen is located in a non-public area for employees of the automobile dealership to review, particularly near the rear of a housing unit 110 in a rear loaded unit. Other forms of computer unit 130 output for reservation reminders are contemplated and within the scope of the present invention.

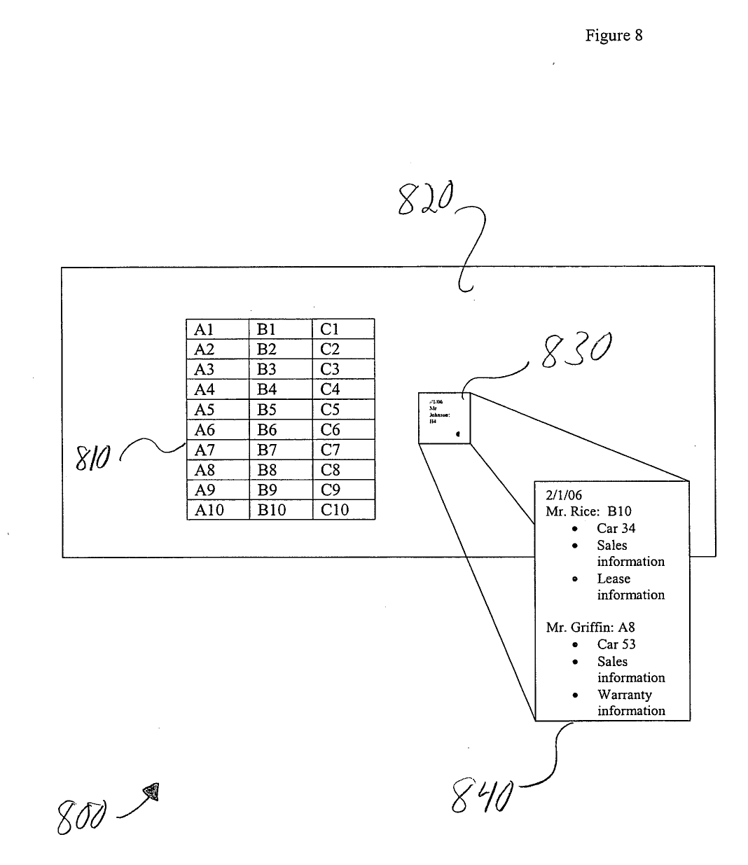

With each reservation in the automobile dealership context, the computer unit 130 also outputs an assignment of a securable compartment and a listing of the objects to be loaded into the securable compartment. FIG. 8 illustrates an example of the computer unit 130's output for a loading session in the automobile dealership context 800.

FIG. 8 illustrates a subset 810 of the housing unit 110 built into wall 820 of an automobile dealership facility. The rear, non-public side of the housing unit 810 is depicted. In an embodiment, the compartments of the housing unit 810 are rear loaded. FIG. 8 also illustrates a display screen 830. The display screen 830 is built into the wall near the housing unit 810. A larger blow-up of the contents displayed on the display screen are shown in blow-up 840 as an example.

In an embodiment, the display screen 830 may display the car reservations for a particular day, as represented by the “2/1/06” shown on the blow-up 840. The information on the blow-up 840 indicates the user that the reservation is for, the compartment to load the user's contents into, and the objects to load into the assigned compartment. For example, for “Mr. Rice” on the blow-up 840, the assigned compartment is B10. The assigned car is in space 34 and the automobile dealership employee is told to include both sales and lease information in the compartment. A dealership employee may review the display unit 830 and understand to load a key for car 34 into compartment B10 and also load both sales and lease information for Mr. Rice into compartment B10. In an embodiment, the display unit 830 may be in communication with one or more input devices so the employee who performs the loading of the objects can indicate to the computer unit 130 that the loading is complete.

In such a manner, an employee may load objects to some, or all of an automobile dealership's automobiles into a housing unit 110. The number of keys to be loaded may depend on the number of reservations for the day. Additionally, as users may generally schedule different periods of time to examine a car, the dealership may have more frequent loading times. For example, the dealership may load the keys on an hourly basis. Upon accepting the reservation, the dealership may ask the user an expected time of arrival. The keys may be loaded based on the expected time of arrival. By using multiple loading sessions, the system 100 may operate with a smaller number of compartments.

Once the housing unit 110 is loaded by the employees, the objects are ready to be distributed to users 125. Upon arriving at the location of the dealership, the user 125 may approach the first input unit 120. The user may review the input console 200 of the first input unit 120 for instructions to initiate the transaction.

The display unit 220 may instruct the user 125 to begin the transaction. For example, the display unit 220 may instruct the user to swipe their credit card in the card reader 210. The information on the credit card is read by the card reader 210 and communicated to the computer unit 130. The computer unit 130 compares at least some of the information on the credit card with the information stored in the computer unit 130 database. For example, the computer unit 130 may compare the name on the credit card with the name's of individuals in the computer unit 130 database. The computer unit 130 may also compare the credit card number on the credit card with credit card numbers in the computer unit 130 data base. In an embodiment, in order to maximize search efficiency, the computer unit 130 may first search files with expected arrival dates and arrival times equal to the date and time the card was swiped. For example, the computer unit 130 may receive the first user input and compare the first user input with the stored information in files having an expected arrival data and time of the date and time the card was swiped. Alternatively, the computer unit 130 searches files in the order the files are stored. Any technique to compare information may be used.

If the credit card that is swiped through the card reader 210 is the same credit card as that which the user provided at the time of booking the reservation, that credit card is charged. If the credit card that is swiped through the card reader 210 is different than the credit card that was provided at the time of booking the reservation, the computer unit 130 asks the user if the user wishes to charge the credit card on file or charge the new credit card. The computer unit has the ability to communicate with credit card companies to verify and charge a credit card.

If the computer unit 130 finds a match of the first user input with previously stored information, the computer unit 130 returns a message of success and displays a request for additional verification from the user 125. In an embodiment, the computer unit 130 displays a numerical key pad on the touch screen 220 as illustrated in FIG. 4. The input console 400 displays a numerical keypad on touch screen 420. The user is requested to enter the PIN number that was issued to them at the time of making the reservation. The user then enters the PIN. In an embodiment, the PIN number is compared with the PIN number stored in the file found to match the first user input data. A match of both the first user input and the second user input is generally used to verify the identity of the user.

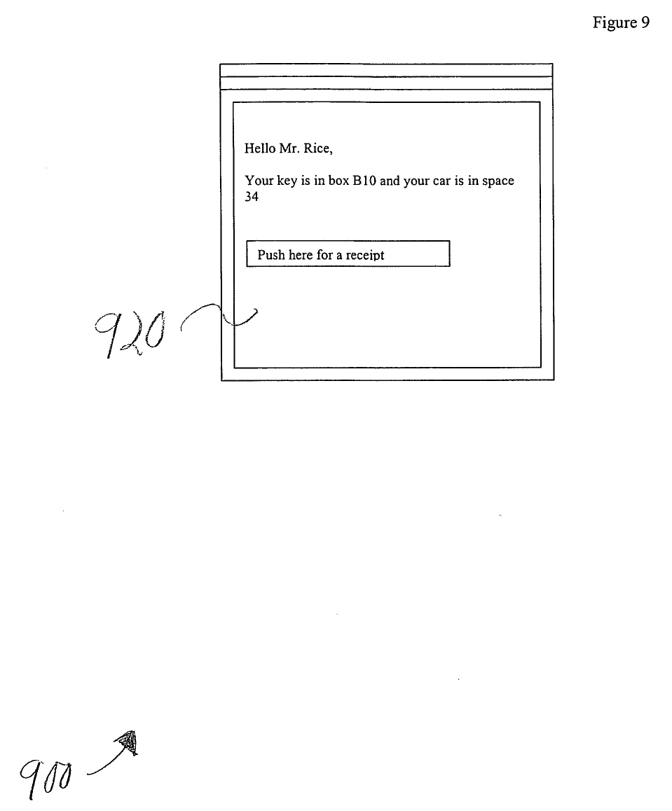

If the PIN number of the second user input matches the stored PIN number, a return message is sent to the first input unit 120. The return message includes the location, in the housing unit 110, of the key for the user's reservation and any additional objects in the compartment. For example, in FIG. 9, input console 900 illustrates screen 920 displaying a welcome message for Mr. Rice. Mr. Rice is an authenticated user and the location of his key and his car is displayed. Additionally, the user may communicate to the input console 920 that the user would like a printed receipt for the transaction.

Upon verification of the individual through information on the individual's credit card and a PIN, the transaction at the first input unit 120 is complete. The computer unit 130 sends an electronic signal to the housing unit 110 to unlock the compartment assigned to the individual. In the example above, the computer unit 130 will unlock compartment B10 for a certain period of time. The compartment may stay unlocked for a period of time determined to be sufficient for a user to find the appropriate compartment. If the individual does not retrieve the object in the given period of time, the compartment relocks. For example, if the individual's key is in compartment B10, the computer unit 130 sends and electronic communication to the housing unit 110 to unlock compartment B10. The user was previously told that the key is in compartment B10 by the first input unit 120. The user may then remove the key from compartment B10. If the user does not remove the key from the compartment B10 in a designated period of time, the compartment B10 will relock. In an embodiment, upon removal of the object by the user, the housing unit 110 may send a message to the computer unit that the object has been removed from the compartment and the compartment is free for reassignment. A record has been created of who obtained the keys and at what time. In an embodiment, the compartment may remain unlocked until the keys are returned to the compartment the keys originated from. Upon return of the keys, the compartment may be relocked and the process repeated.

In another embodiment of the automobile dealership context, instead of a customer utilizing the system 100, the employees of the dealership may utilize the system 100 to track keys to the automobiles. For example, the keys may be stored in compartments of the housing unit 110. An employee, upon being hired, may be issued a profile that is stored in the computer unit 130. The employee may utilize an identification card with the first input unit 120 for authorization. In an embodiment, the employee may enter her personal identification number that she was previously issued and granted access to a menu. The menu may display the current inventory of automobiles and the compartment numbers of the housing unit 110 in which the keys are stored. The employee may select which key she would like to “check-out” from the menu. The corresponding compartment of the housing unit 110 may then be unsecured and the employee may retrieve the key. In such an embodiment, the keys to the automobiles may be tracked in an efficient fashion. Additionally, in an embodiment, when the key is returned to the compartment, a sensor within the compartment may sense the key and communicate to the computer unit 130 that the key has been returned.

FIGS. 1000-1200 illustrate state diagrams 1000-1200 respectively, in accordance with an embodiment of the present invention. The state diagram 1000 represents an example embodiment of a state progression of a main program that the computer software running on the computer unit 130 may execute. The state diagram 1100 represents an example embodiment of a state progression of a service routine that may be called by the main program 1000. The state diagram 1200 represents an example embodiment of a state progression of a file compare routine that may be called by the main program 1000. The state diagrams 1000-1200 represent an example of how to implement computer software in an accordance with an embodiment of the present invention. As the state diagrams 1000-1200 are examples, other implementations and variations of the computer software may be utilized in accordance with an embodiment of the present invention.

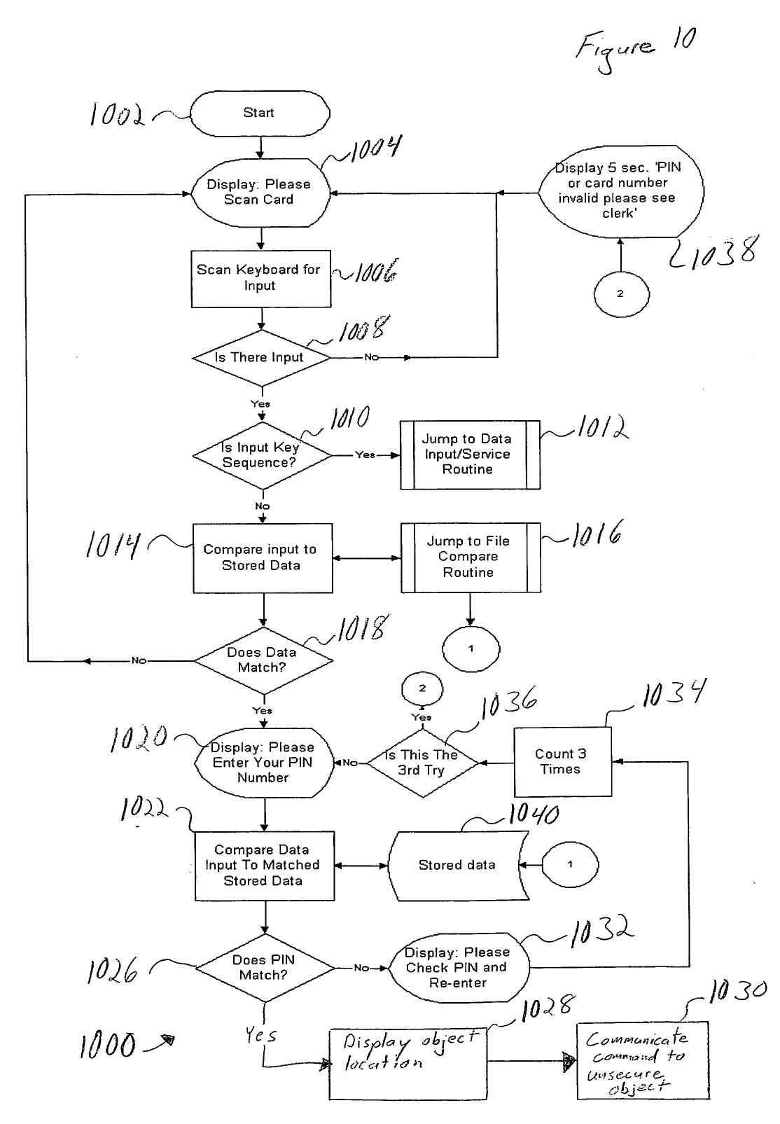

FIG. 10 illustrates a state diagram 1000 that illustrates an example of a main program state progression that may be used in accordance with an embodiment of the present invention. Element 1002 illustrates a start position of the software program. At element 1004, the computer software program may display on the display unit “Please Scan Card” indicating to the user to initiate the transaction by scanning their card. The computer program scans for input at element 1006. Elements 1004 and 1006 represent the “wait for input” state. The decision box 1008 represents the query by the software for input. If there is no input, the computer program loops back to the “waiting for input” state at elements 1004 and 1006.

If there is input at 1008, the software checks if the input is an input key sequence at 1010. An input key sequence is a unique code that indicates to the computer unit 1030 that the user wants to utilize an administrative menu. If the input is an input key sequence, then the software calls the “Jump to Data Input/Service Routine” at element 1012.

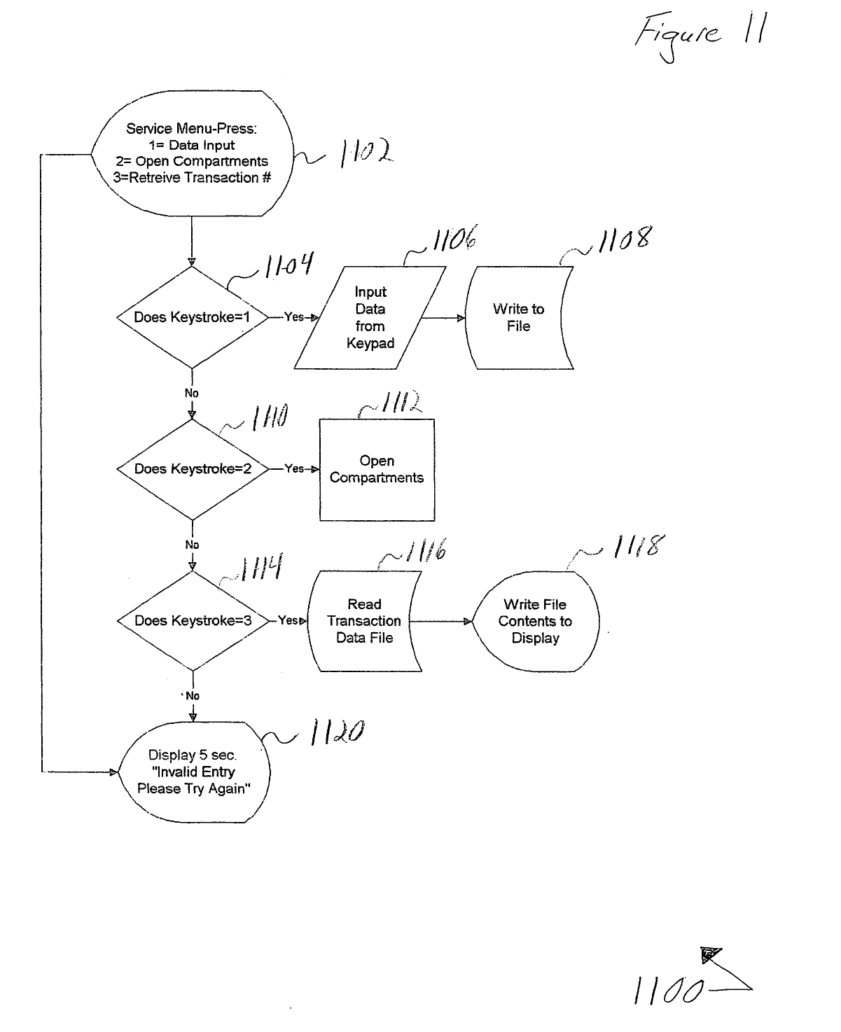

FIG. 11 illustrates a state diagram 1100 that illustrates an example of an input/service routine that may be used with the main program 1000 in accordance with an embodiment of the present invention. At initiation of the input/service routine, the display unit may display the contents of the 1102 element. A user may select “1” to input data to the computer unit 130, a “2” to open the compartments of the housing unit 110, or a “3” to read the transaction data file. If a wrong key is pressed, the display unit displays “Invalid entry, Please try again” for 5 seconds. At element 1104, the software checks if the user has entered “1”. If yes, the software receives input from the keypad at 1106 and writes to memory at 1108. If the user did not enter “1”, the software checks if the user has selected “2”. If yes, the software communicates an electronic command to the housing unit 110 to open the compartments. In an embodiment, the user may select individual compartments to open. If the user did not enter “2”, the software checks if the user has selected “3” at 1114. If the user has selected “3”, the software reads the transaction data file at 1116 and writes the file contents to the display at 1118. If the user did not enter “3”, then the display instructs the user to try again at 1120.

Referring back to FIG. 10 and the main program state diagram 1000, if the input is not an input key sequence at element 1010, the input is compared to stored data at 1014. In order to compare the input to stored data, the main program 600 calls the “File Compare Routine” at 1016.

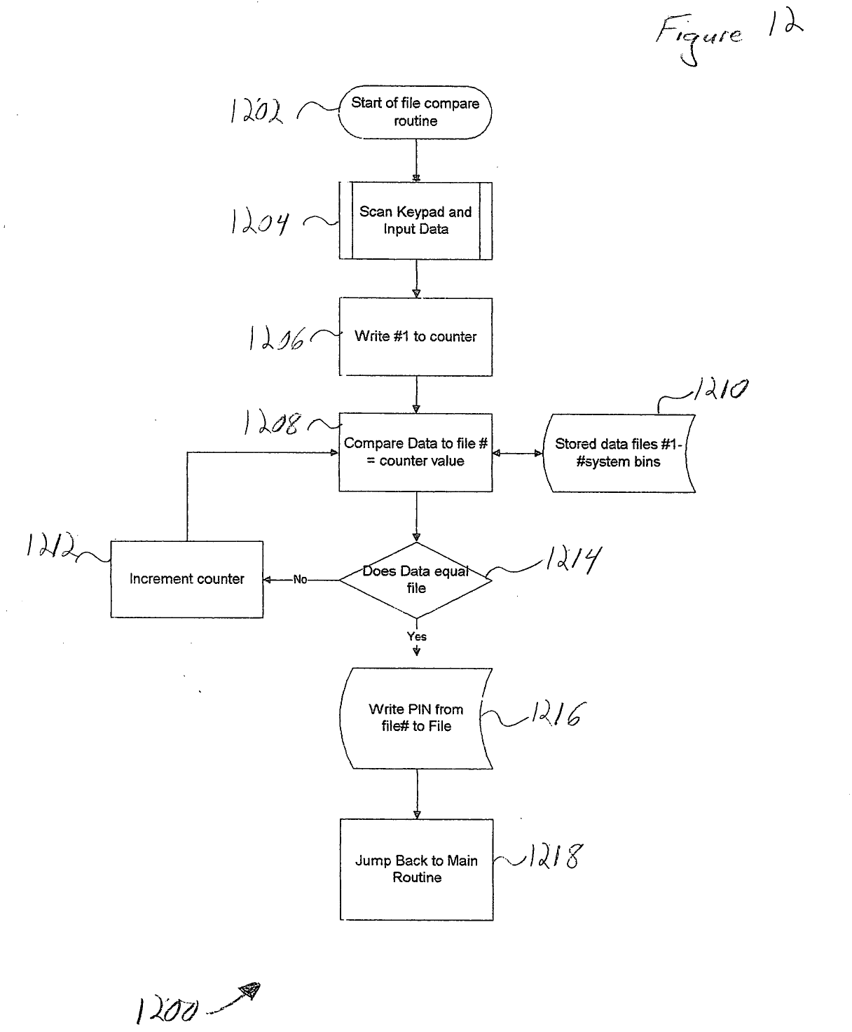

FIG. 12 illustrates a state diagram 1200 that illustrates an example of a “file compare routine” that may be used with the main program 1000 in accordance with an embodiment of the present invention. Element 1202 is the start of the file compare routine. At element 1204, the routine 1200 receives the input data. At 1206, the routine 1200 initiates a counter. On the first attempt, the value of the counter may equal “1”. At element 1208, the routine 1200 compares the input data to the stored data that is stored in the bin number equal to the counter number. For example, if the counter value is 1, the input data is compared to the data stored at bin number 1 at element 1210. The result is returned and at element 1214, if the result is that the input data is equal to the stored data in a particular bin, the software moves to element 1216. If there is no match, the counter is increment at 1212. Incrementing the counter causes the routine at 1210 to look at the next file for a match. The process loops until a match is made and 1214 goes to the next step at 816. At element 1216, the PIN from the file is written to a temporary file, as indicated by the circled “1” exiting the box 1016 in FIG. 10. At 1218, the routine jumps back to the main routine 1000 and reports the result to 1014.

Referring back to FIG. 10 main program, element 1018 allows the user to progress to element 1020 if the file compare routine returned a successful result. At element 1020, the user is prompted to enter a PIN. Upon, receiving input from the user, the input is compared to the PIN stored at element 1040. In an embodiment, the input from the user is only compared with the PIN that was retrieved from the file compare routine and stored at 1040. In such a manner, processing power is minimized as the PIN does not have to be compared to all files until a match is made. Rather, the input is only compared to the only stored data that will indicate a successful match.

If at 1026, the PIN stored at 1040 matches the user input, the object's location is displayed to the user at 1028 and an electronic command is issued to the housing unit 110 to unlock the appropriate compartment at 1030. If the input does not match the PIN at 1026 the user is prompted to reenter the Pin at 1032. The user may only have two chances to renter the PIN, and thus each time is incremented at 1034. If the user is on their third try, at 1036, the user display states for 5 seconds “PIN or card number invalid please see clerk” at 1038.

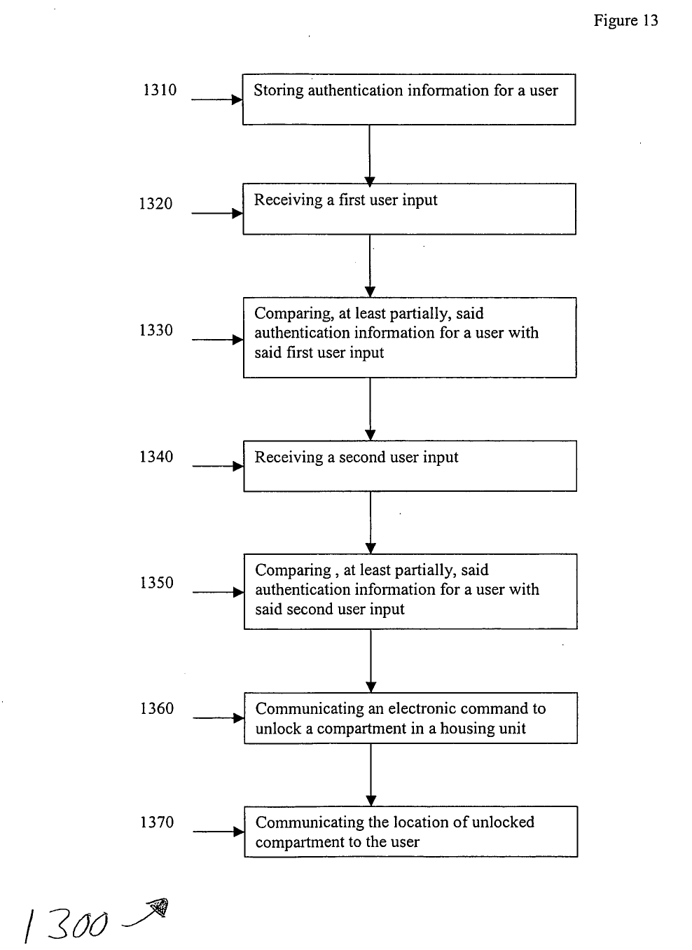

FIG. 13 illustrates a method 1300 for delivering one or more objects to a user. The method 900 may be executed by computer software having a similar or different state flow sequence as described in state diagrams 1000-1200. The method 1300 may be executed by computer software residing on the computer unit 130. Alternatively, the method 1300 may be executed by computer software as part of a computer system, such as a server or database, different from where the computer software is stored. In another alternative, the computer software may be executed and stored external to the computer unit 130. The computer unit 130, however, may be in communication with the computer system or server executing and/or storing the computer software for the method 1300.

The method 1300 may be used to deliver one or more objects to a user. For example, the method 1300 may be used to deliver one or more objects to a user where the user has previously made a reservation. At step 1310, computer software stores authentication information for a user. The authentication information is stored along with the user's reservation. The authentication information may be information communicated from the user to the computer software or information communicated from the computer software to the user.

At step 1320, the computer software receives a first user input. In an embodiment, the first user input may be input from a user received at a time and place corresponding to the user's reservation. In an embodiment, the first user input may be information contained on an electromagnetic card and scanned through an electromagnetic card reader. The first user input may be input on an electromagnetic card and may include the user's name and credit card number. The first user input may also be input from a keypad or input from a touch screen display unit. The first user input may also be information from a finger print reader, a face recognition reader, or other identification techniques.

At step 1330, the computer software compares the authentication information obtained from step 1310 with, at least partially, the first user input. In an embodiment, the first user input may be the user's name and/or credit card number. The computer software may compare the user's name and/or credit card number with stored names and/or credit card numbers. In an embodiment, the computer software may compare the first user input to the authentication information in a sequential manner, as described with respect to state diagrams 1000 and 1200. In another embodiment, the computer software may compare the first user input to the authentication information having an expected check-in or arrival date equal to the current date. For example, the computer software may look for a match to the first user input in files where a match may be expected, i.e. in files having an expected check-in date of the current date. If a match is not found in the expected files, the computer software may compare files having a different check-in date than the current date.

At step 1340, the computer software receives a second user input. In an embodiment, the second user input may be a personal identification number. The personal identification number may be input as part of a keypad or a touch screen display. The second user input may also be input from an electromagnetic card reader a finger print reader, a face recognition reader, or other identification techniques.

At step 1350, the computer software compares previously stored information to the second user input acquired at step 1340. In an embodiment, the second user input may be a personal identification number. The computer software may compare the user's personal identification number with the stored personal identification number for that particular user. In such a manner, the computer software does not have to cycle through each of the stored personal identification numbers searching for a match. Rather, the computer software compares the second user input to the expected personal identification number. In another embodiment, the computer software may compare the second user input to the stored personal identification numbers looking for a match. The computer software may then ensure the first user input and the second user input are associated with the same user. The techniques described are only examples and other techniques for verification of a user's identity may be used.

At step 1360, if the user's identity has been verified, the computer software communicates an electronic command to unsecure the object. In an embodiment, the computer software may send an electronic command to a compartment housing the object to unlock the compartment. The electronic command may be an analog or digital command. In an embodiment, the compartment may return communication to the computer software acknowledging that the electronic command was received and correctly executed. At step 1370, the location of the object may be communicated to the user. The user may then physically obtain the object. In an embodiment, the compartment may detect when the object is removed and communicate that the compartment is empty to the computer software. The computer software may then organize the empty compartments for reloading.

The system and method described above may be carried out as part of a computer-readable storage medium including a set of instructions for a computer. The set of instructions includes a storing routine for storing authentication information for a user. The authentication information is stored along with the user's reservation. The authentication information may be information communicated from the user to the computer software or information communicated from the computer software to the user.

The set of instructions also includes a first receiving routine for receiving a first user input. In an embodiment, the first user input may be input from a user received at a time and place corresponding to the user's reservation. In an embodiment, the first user input may be information contained on an electromagnetic card and scanned through an electromagnetic card reader. The first user input may be input on an electromagnetic card and may include the user's name and credit card number. The first user input may also be input from a keypad or input from a touch screen display unit. The first user input may also be information from a finger print reader, a face recognition reader, or other identification techniques.

The set of instructions also includes a first comparing routine for comparing, at least partially, the authentication information for a user with the first user input. In an embodiment, the first user input may be the user's name and/or credit card number. The computer software may compare the user's name and/or credit card number with stored names and/or credit card numbers. In an embodiment, the computer software may compare the first user input to the authentication information in a sequential manner, as described with respect to state diagrams 1000 and 1200. In another embodiment, the computer software may compare the first user input to the authentication information having an expected check-in or arrival date equal to the current date. For example, the computer software may look for a match to the first user input in files where a match may be expected, i.e. in files having an expected check-in date of the current date. If a match is not found in the expected files, the computer software may compare files having a different check-in date than the current date.

The set of instructions also includes a second receiving routine for receiving a second user input. In an embodiment, the second user input may be a personal identification number. The personal identification number may be input as part of a keypad or a touch screen display. The second user input may also be input from an electromagnetic card reader a finger print reader, a face recognition reader, or other identification techniques.

The set of instructions also includes a second comparing routine for comparing, at least partially, the authentication information for a user with the second user input. In an embodiment, the second user input may be a personal identification number. The computer software may compare the user's personal identification number with the stored personal identification number for that particular user. In such a manner, the computer software does not have to cycle through each of the stored personal identification numbers searching for a match. Rather, the computer software compares the second user input to the expected personal identification number. In another embodiment, the computer software may compare the second user input to the stored personal identification numbers looking for a match. The computer software may then ensure the first user input and the second user input are associated with the same user. The techniques described are only examples and other techniques for verification of a user's identity may be used.

The set of instructions also includes a first communication routine for communicating an electronic command to unlock a compartment in a housing unit. In an embodiment, the computer software may send an electronic command to a compartment housing the object to unlock the compartment. In an embodiment, the compartment may return communication to the computer software acknowledging that the electronic command was received and correctly executed.

The set of instructions also includes a second communication routine for communicating the location of the unlocked compartment to the user. The user may then physically obtain the object. In an embodiment, the compartment may detect when the object is removed and communicate that the compartment is empty to the computer software. The computer software may then organize the empty compartments for reloading.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A method of delivering an object to a user, said method comprising:
storing authentication information;
receiving a first user input;
comparing said authentication information with said first user input;
receiving a second user input;
comparing said authentication information with said second user input;
communicating an electronic command to unsecure said object; and
communicating the location of the object to said user.

2. The method of claim 1, wherein said step of storing authentication information further includes storing reservation information.

3. The method of claim 1, wherein said first user input includes data stored on an electromagnetic card.

4. The method of claim 2, wherein said authentication information and reservation information are received from an external network.

5. The method of claim 3, wherein said step of comparing said authentication information with said first user input further includes comparing at least some of said data stored on said electromagnetic card with said authentication information.

6. The method of claim 1, wherein said second user input includes a personal identification number.

7. The method of claim 6, wherein said step of comparing said authentication information with said second user input further includes comparing said personal identification number with said authentication information.

8. The method of claim 1, wherein said step of communicating an electronic command to unsecure said object further includes unsecuring said object by unlocking a secure compartment.

9. The method of claim 1, wherein said step of communicating the location of the object to said user includes visually displaying said location of said object.

10. The method of claim 1, further including the step of detecting the absence of said object and communicating an electronic signal to identify said absence of said object.

11. A system for delivering an object to a user, said system comprising:
an input unit for receiving input from a user;
a housing unit for housing said object, said housing unit having an access mechanism for controlling access to said object; and,
a computer unit for manipulating and storing data, said computer unit executing computer software for communicating with said user, and communicating an electronic command to said housing unit, said electronic command being a command to unlock said access mechanism of said housing unit.

12. The system of claim 11, wherein said input unit includes a touch screen display unit.

13. The system of claim 11, wherein said input unit includes an electromagnetic card reader.

14. The system of claim 11, wherein said housing unit has a plurality of compartments.

15. The system of claim 14, further including a display unit for displaying information for loading said plurality of compartments.

16. The system of claim 11, further including a second input unit.

17. The system of claim 11, wherein said input unit includes a contact-less card reader.

18. The system of claim 11, wherein said object is a key.

19. The system of claim 11, wherein said data stored on said computer unit includes reservation and authentication data.

20. The system of claim 19, wherein said authentication data and reservation data are received from an external network.

21. A computer-readable storage medium including a set of instructions for a computer, the set of instructions comprising:
a storing routine for storing authentication information;
a first receiving routine for receiving a first user input;
a first comparing routine for comparing said authentication information with said first user input;
a second receiving routine for receiving a second user input;
a second comparing routine for comparing said authentication information with said second user input;
a first communicating routine for communicating an electronic command to unsecure said object; and
a second communicating routine for communicating the location of the object to said user.
